(19) United States
(12) Patent Application Publication
(10) Pub. No.: US 2014/0088930 A1
(43) Pub. Date: Mar. 27, 2014

(54) APPARATUS FOR ARRANGEMENT SIMULATION OF BUILDING ENERGY MANAGEMENT FACILITIES

(71) Applicant: ELECTRONICS AND TELECOMMUNICATIONS RESEARCH INSTITUTE, Daejeon (KR)

(72) Inventors: Jong Won KIM, Daejeon (KR); Youn Kwae JEONG, Daejeon (KR); IL Woo LEE, Daejeon (KR)

(73) Assignee: ELECTRONICS AND TELECOMMUNICATIONS RESEARCH INSTITUTE, Daejeon (KR)

(21) Appl. No.: 13/947,700

(22) Filed: Jul. 22, 2013

(30) Foreign Application Priority Data
Sep. 27, 2012 (KR) 10-2012-0107936

(51) Int. Cl. G06F 17/50

(52) U.S. Cl. CPC G06F 17/50
USPC 703/1

(57) ABSTRACT

In accordance with the embodiment, for various measuring instruments such as temperature sensor, humidity sensor, temperature-humidity sensor, illuminance sensor, occupancy sensor, CO₂ sensor, fine dust sensor and pressure sensor or various metering instruments such as electricity meter, gas meter, hot water meter, cold water meter, flow meter, and air flow meter, there are provided a function to automatically arrange and display each measuring instrument and each metering instrument at the optimal location or an installation cost based location to manage and control building energy and environment and a function to calculate and display investment earnings rate of each measuring instrument and each metering instrument.

### RELATED APPLICATIONS

This application claims the benefit of Korean Patent Application No. 10-2012-0107936, filed on Sep. 27, 2012, which is hereby incorporated by reference as if fully set forth herein.

### FIELD OF THE INVENTION

The present invention relates to an apparatus for an arrangement simulation of building energy management facilities, and more particularly, to an apparatus for an arrangement simulation of building energy management facilities, capable of simulating an arrangement of various facilities to manage and control a building energy and environment to be optimized in their locations, thereby providing arrangement information.

### BACKGROUND OF THE INVENTION

As is well known in the art, in order to manage and control a building energy and environment, there are needed various measuring instruments such as temperature sensor, humidity sensor, temperature-humidity sensor, illuminance sensor, occupancy sensor, CO₂ sensor, fine dust sensor and pressure sensor and there are needed various metering instruments such as electricity meter, gas meter, hot water meter, cold water meter, flow meter, and air flow meter.

Further, in order to manage and control building energy and environment efficiently, it is extremely important to arrange such facilities, that is, various measuring instruments and various metering instruments in appropriate locations.

In the art, there is a technology to make a modeling a sensor node, a gateway and a server in consideration of a three-dimensional space placed in reality and communication obstacles placed in the space.

However, such a technology has a problem that it can be applied only when the sensor node, gateway and server that are dedicated for a wireless sensor network are installed and cannot be applied when arranging facilities used to manage and control building energy and environment.

### SUMMARY OF THE INVENTION

In view of the above, the present invention provides an apparatus for an arrangement simulation of building energy management facilities, capable of simulating an arrangement of various facilities to manage and control building energy and environment to be optimized in their locations, thereby providing arrangement information.

In accordance with a first aspect of the present invention, there is provided an apparatus for simulation of building energy management facilities, includes: a building DB unit configured to store building characteristic data including building structure data, building energy facility distribution diagram data and measuring instrument list data; a user interface unit configured to receive installation cost information of a measuring instrument and simulation method information; a measuring instrument simulation arrangement unit configured to capture building characteristics based on the building structure data and the building energy facility distribution diagram data and simulate an arrangement of measuring instruments included in the measuring instrument list data in accordance with the measuring instrument installation cost information and the simulation method information; and an arrangement information visualization unit configured to visualize arrangement information generated by the measuring instrument simulation arrangement unit.

Further, the apparatus may further comprise a DB editing unit configured to edit the building structure data, the building energy facility distribution diagram data and the measuring instrument list data stored in the building DB unit in accordance with building information modeling information and industry foundation classes information received by the user interface unit.

Further, the measuring instrument simulation arrangement unit provides optimal arrangement coordinate information and installation cost-based arrangement coordinate information of the measuring instrument to the arrangement information visualization unit for the visualization thereof.

Further, the measuring instrument simulation arrangement unit is configured to provide optimal total amount information and measuring instrument installation cost information, the apparatus further comprises an investment earnings rate simulation calculation unit configured to calculate investment earnings rate information based on the optimal total amount information and measuring instrument installation cost information; and an investment earnings rate information visualization unit configured to visualize the investment earnings rate information calculated.

Further, the measuring instrument simulation arrangement unit comprises a measuring instrument optimal reference area calculation unit configured to calculate the optimal reference area of the measuring instrument based on the measuring instrument installation cost information, the simulation method information, the measuring instrument list information and the building characteristic data; a measuring instrument optimal amount calculation unit configured to calculate the optical amount of the measuring instrument based on the optimal reference area of the measuring instrument; a measuring instrument optimal arrangement unit configured to calculate the optimal arrangement coordinate of the measuring instrument based on the building structure data, the building energy facility distribution diagram data, the optimal amount data of the measuring instrument and the building characteristic data; a measuring instrument unit price calculation unit configured to calculate unit price of the measuring instrument based on the measuring instrument installation cost information, the simulation method information and the measuring instrument list information; a measuring instrument optimal total amount calculation unit configured to calculate the optimal total amount of the measuring instrument based on the optimal amount of the measuring instrument and the unit price of the measuring instrument; a measuring instrument installation cost calculation unit configured to calculate an installation cost of the measuring instrument based on the measuring instrument installation cost information, the simulation method information, the measuring instrument list information and the building characteristic data; a measuring instrument installation cost based amount calculation unit configured to calculate an installation cost based amount of the measuring instrument based on a unit price of the measuring instrument and an installation cost of the measuring instrument; a measuring instrument installation cost based reference area calculation unit configured to calculate an installation cost based reference area of the measuring instrument based on an installation coat based amount of the measuring instrument and the building characteristic data; and a measuring instrument installation cost based arrangement unit configured to calculate an installation cost based arrangement coordinate of the measuring instrument based on an installation cost based reference area of the measuring instrument.

In accordance with a second aspect of the present invention, there is provided an apparatus for simulation of building energy management facilities, includes: a building DB unit configured to store building characteristic data including building structure data, building energy facility distribution diagram data and metering instrument list data; a user interface unit configured to receive metering instrument installation cost information and simulation method information; a metering instrument simulation arrangement unit configured to capture building characteristics based on the building structure data and the building energy facility distribution diagram data and simulate an arrangement of metering instruments included in the metering instrument list data in accordance with the metering instrument installation cost information and the simulation method information; and an arrangement information visualization unit configured to visualize arrangement information generated by the metering instrument simulation arrangement unit.

Further, the apparatus may further comprise a DB editing unit configured to edit the building structure data, the building energy facility distribution diagram data and the measuring instrument list data stored in the building DB unit in accordance with building information modeling information and industry foundation classes information received by the user interface unit.

Further, the metering instrument simulation arrangement unit is configured to provide optimal arrangement coordinate information and installation cost based arrangement coordinate information of the measuring instrument to the arrangement information visualization unit for the visualization thereof.

Further, the metering instrument simulation arrangement unit is configured to provide optimal total amount information and metering instrument installation cost information, the apparatus further comprises an investment earnings rate simulation calculation unit configured to calculate investment earnings rate information based on optimal total amount information and metering instrument installation cost information; and an investment earnings rate information visualization unit configured to visualize the investment earnings rate information calculated.

Further, the metering instrument simulation arrangement unit comprises a metering instrument optimal reference area calculation unit configured to calculate the optimal reference area of the metering instrument based on the metering instrument installation cost information, the simulation method information, the metering instrument list information and the building characteristic data; a metering instrument optimal amount calculation unit configured to calculate the optical amount of the metering instrument based on the optimal reference area of the metering instrument; a metering instrument optimal arrangement unit configured to calculate the optimal arrangement coordinate of the metering instrument based on the building structure data, the building energy facility distribution diagram data, the optimal amount data of the metering instrument and the building characteristic data; a metering instrument unit price calculation unit configured to calculate a unit price of the metering instrument based on the metering instrument installation cost information, the simulation method information and the metering instrument list information; a metering instrument optimal total amount calculation unit configured to calculate the optimal total amount of the metering instrument based on the optimal amount of the metering instrument and the unit price of the metering instrument; a metering instrument installation cost calculation unit configured to calculate an installation cost of the metering instrument based on the metering instrument installation cost information, the simulation method information, the metering instrument list information and the building characteristic data; a metering instrument installation cost based amount calculation unit configured to calculate an installation cost of the metering instrument based amount of the metering instrument based on a unit price of the metering instrument and an installation cost of the metering instrument; a metering instrument installation cost based reference area calculation unit configured to calculate an installation cost based reference area of the metering instrument based on an installation coat based amount of the metering instrument and the building characteristic data; and a metering instrument installation cost based arrangement unit configured to calculate an installation cost based arrangement coordinate of the metering instrument based on an installation cost based reference area of the metering instrument.

In accordance with a third aspect of the present invention, there is provided an apparatus for simulation of building energy management facilities, includes: a building DB unit configured to store building characteristic data including building structure data, building energy facility distribution diagram data, measuring instrument list data and metering instrument list data; a user interface unit configured to receive measuring instrument installation cost information, metering instrument installation cost information and simulation method information; a measuring instrument simulation arrangement unit configured to capture building characteristics based on the building structure data and the building energy facility distribution diagram data and simulate an arrangement of measuring instruments included in the measuring instrument list data in accordance with the measuring instrument installation cost information and the simulation method information; a metering instrument simulation arrangement unit configured to capture building characteristics based on the building structure data and the building energy facility distribution diagram data and simulate an arrangement of metering instruments included in the metering instrument list data in accordance with the metering instrument installation cost information and the simulation method information; and an arrangement information visualization unit configured to visualize arrangement information generated by the measuring instrument simulation arrangement unit and arrangement information generated by the metering instrument simulation arrangement unit.

Further, the apparatus may further comprise a DB editing unit configured to edit the building structure data, the building energy facility distribution diagram data, the measuring instrument list data and the metering instrument list data stored in the building DB unit in accordance with building information modeling information and industry foundation classes information received by the user interface unit.

Further, the measuring instrument simulation arrangement unit is configured to provide optimal arrangement coordinate information and installation cost based arrangement coordinate information of the measuring instrument to be visualized by the arrangement information visualization unit, and wherein the metering instrument simulation arrangement unit is configured to provide optimal arrangement coordinate information and installation cost based arrangement coordinate information of the measuring instrument to be visualized by the arrangement information visualization unit.

Further, the measuring instrument simulation arrangement unit is configured to provide the optimal total amount information and measuring instrument installation cost information, and the metering instrument simulation arrangement unit provides optimal total amount information and metering instrument installation cost information, the apparatus further comprises an investment earnings rate simulation calculation unit configured to calculate investment earnings rate information based on the optimal total amount information and measuring instrument installation cost information, and optimal total amount information and metering instrument installation cost information; and an investment earnings rate information visualization unit configured to visualize the investment earnings rate information calculated.

Further, the measuring instrument simulation arrangement unit comprises a measuring instrument optimal reference area calculation unit configured to calculate the optimal reference area of the measuring instrument based on the measuring instrument installation cost information, the simulation method information, the measuring instrument list information and the building characteristic data; a measuring instrument optimal amount calculation unit configured to calculate the optical amount of the measuring instrument based on the optimal reference area of the measuring instrument; a measuring instrument optimal arrangement unit configured to calculate the optimal arrangement coordinate of the measuring instrument based on the building structure data, the building energy facility distribution diagram data, optimal amount data of the measuring instrument and the building characteristic data; a measuring instrument unit price calculation unit configured to calculate a unit price of the measuring instrument based on the measuring instrument installation cost information, the simulation method information and the measuring instrument list information; a measuring instrument optimal total amount calculation unit configured to calculate the optimal total amount of the measuring instrument based on the optimal amount of the measuring instrument and the unit price of the measuring instrument; a measuring instrument installation cost calculation unit configured to calculate an installation cost of the measuring instrument based on the measuring instrument installation cost information, the simulation method information, the measuring instrument list information and the building characteristic data; a measuring instrument installation cost based amount calculation unit configured to calculate an installation cost based amount of the measuring instrument based on a unit price of the measuring instrument and an installation cost of the measuring instrument; a measuring instrument installation cost based reference area calculation unit configured to calculate an installation cost based reference area of the measuring instrument based on the installation coat based amount of the measuring instrument and the building characteristic data; and a measuring instrument installation cost based arrangement unit configured to calculate an installation cost based arrangement coordinate of the measuring instrument based on the installation cost based reference area of the measuring instrument.

Further, the metering instrument simulation arrangement unit comprises a metering instrument optimal reference area calculation unit configured to calculate the optimal reference area of the metering instrument based on the metering instrument installation cost information, the simulation method information, the metering instrument list information and the building characteristic data; a metering instrument optimal amount calculation unit configured to calculate the optical amount of the metering instrument based on the optimal reference area of the metering instrument; a metering instrument optimal arrangement unit configured to calculate the optimal arrangement coordinate of the metering instrument based on the building structure data, the building energy facility distribution diagram data, the optimal amount data of the metering instrument and the building characteristic data; a metering instrument unit price calculation unit configured to calculate a unit price of the metering instrument based on the metering instrument installation cost information, the simulation method information and the metering instrument list information; a metering instrument optimal total amount calculation unit configured to calculate the optimal total amount of the metering instrument based on the optimal amount of the metering instrument and the unit price of the metering instrument; a metering instrument installation cost calculation unit configured to calculate an installation cost of the metering instrument based on the metering instrument installation cost information, the simulation method information, the metering instrument list information and the building characteristic data; a metering instrument installation cost based amount calculation unit configured to calculate an installation cost based amount of the metering instrument based on a unit price of the metering instrument and an installation cost of the metering instrument; a metering instrument installation cost based reference area calculation unit configured to calculate an installation cost based reference area of the metering instrument based on an installation coat based amount of the metering instrument and the building characteristic data; and a metering instrument installation cost based arrangement unit configured to calculate an installation cost based arrangement coordinate of the metering instrument based on an installation cost based reference area of the metering instrument.

In accordance with the embodiment of the present invention, for various measuring instruments such as temperature sensor, humidity sensor, temperature-humidity sensor, illuminance sensor, occupancy sensor, CO₂ sensor, fine dust sensor and pressure sensor or various metering instruments such as electricity meter, gas meter, hot water meter, cold water meter, flow meter, and air flow meter, there are provided a function to automatically arrange and display each measuring instrument and each metering instrument at the optimal location or an installation cost based location to manage and control building energy and environment and a function to calculate and display investment earnings rate of each measuring instrument and each metering instrument.

Therefore, the present invention has an effect that it can be applied when arranging facilities to manage and control building energy and environment.

### BRIEF DESCRIPTION OF THE DRAWINGS

The above and other objects and features of the present invention will become apparent from the following description of embodiments given in conjunction with the accompanying drawings, in which:

FIG. 1 is a block diagram of an apparatus for arrangement simulation of building energy management facilities in accordance with an embodiment of the present invention;

FIG. 2 is a detailed block diagram of a simulation arrangement unit for measuring instruments in accordance with an embodiment of the present invention; and

FIG. 3 is a detailed block diagram of a simulation arrangement unit for metering instruments in accordance with an embodiment of the present invention.

### DETAILED DESCRIPTION OF THE EMBODIMENTS

Hereinafter, embodiments of the present invention will be described in detail with reference to the accompanying drawings.

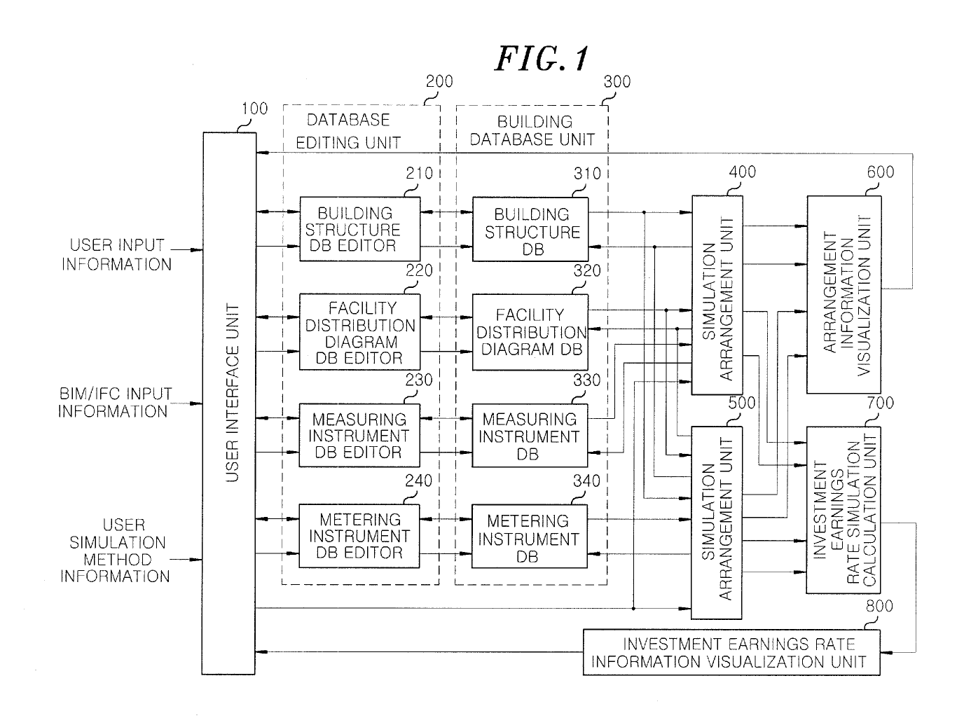

FIG. 1 is a block diagram of an apparatus for an arrangement simulation of building energy management facilities in accordance with an embodiment of the present invention.

Referring to FIG. 1, an apparatus for an arrangement simulation of equipment arrangement in accordance with an embodiment of the present invention includes a user interface unit 100, a database (DB) editing unit 200, a building DB unit 300, a simulation arrangement unit 400 for measuring instruments, a simulation arrangement unit 500 for metering instruments, an arrangement information visualization unit 600, an investment earnings rate simulation calculation unit 700 and an investment earnings rate information visualization unit 800.

The building database unit 300 stores building characteristic data including building structure data, building energy facility distribution diagram data, measuring instrument list data and metering instrument list data. Such a building database unit 300 includes a building structure DB 310 that stores the building structure data, a facility distribution diagram DB 320 that stores the building energy facility distribution diagram data, a measuring instrument DB 330 that stores the measuring instrument list data, and a metering instrument DB 340 that stores the metering instrument list data.

The user interface unit 100 receives measuring instrument installation cost information, metering instrument installation cost information, BIM (Building Information Modeling information)/IFC (Industry Foundation Classes) information and simulation method information.

The measuring instrument simulation arrangement unit 400 captures building characteristics based on the building structure data and the building energy facility distribution diagram data in the building DB unit 300, and simulates an arrangement of the measuring instruments included in the measuring instrument list data in accordance with the measuring instrument installation cost information and simulation method information that are received through the user interface unit 100. Further, the simulation arrangement unit 400 provides optimal arrangement coordinate information and installation cost based arrangement coordinate information of the measuring instruments, so that the measuring instruments are visualized by the arrangement information visualization unit 600. In addition, the simulation arrangement unit 400 provides the investment earnings rate simulation calculation unit 700 with optimal total amount information and measuring instrument installation cost information.

The simulation arrangement unit 500 captures building characteristics based on the building structure data and building energy facility distribution diagram data in the building DB unit 300 and simulates an arrangement of the metering instruments included in the metering instrument list data in accordance with metering instrument installation cost information and simulation method information that are received through the user interface unit 100. Further, the simulation arrangement unit 500 provides optimal arrangement coordinate information and installation cost based arrangement coordinate information of the metering instruments, so that the metering instruments are visualized by the arrangement information visualization unit 600. In addition, the simulation arrangement unit 400 provides the investment earnings rate simulation calculation unit 700 with optimal total amount information and metering instrument installation cost information.

The arrangement information visualization unit 600 processes arrangement information of the simulation arrangement unit 400 and arrangement information of the simulation arrangement unit 500 to be visualized.

The DB editing unit 200 edits the building structure data, building energy facility distribution diagram data, metering instrument list data or metering instrument list data stored in the building DB unit 300 in accordance with the building information modeling information and the industry foundation classes information received by the user interface unit 100. Such a DB editing unit 200 includes a building structure DB editor 210, a facility distribution diagram DB editor 220, a measuring instrument DB editor 230 for measuring instruments, a metering instrument DB editor 240 for metering instruments.

The investment earnings rate simulation calculation unit 700 calculates investment earnings rate information of the measuring instruments based on the optimal total amount information and the measuring instrument installation cost information, and investment earnings rate information of the metering instrument based on the optimal total amount information and the metering instrument installation cost information.

The investment earnings rate information visualization unit 800 processes the investment earnings rate information of the measuring instruments and the investment earnings rate information of the metering instruments that are calculated by the investment earnings rate simulation calculation unit 700 so that they are visualized.

Meanwhile, while the embodiment shown in FIG. 1 illustrates an apparatus for arrangement simulation of building energy management facilities, which simulates an arrangement of both the measuring instruments and metering instruments and provides the arrangement information, it is possible to exclude the simulation arrangement unit 500 in case of an apparatus for simulation of facility arrangement to simulate an arrangement of measuring instruments and provide arrangement information, and to exclude the simulation arrangement unit 400 in case of an apparatus for simulation of facility arrangement to simulate an arrangement of metering instruments and provide arrangement information.

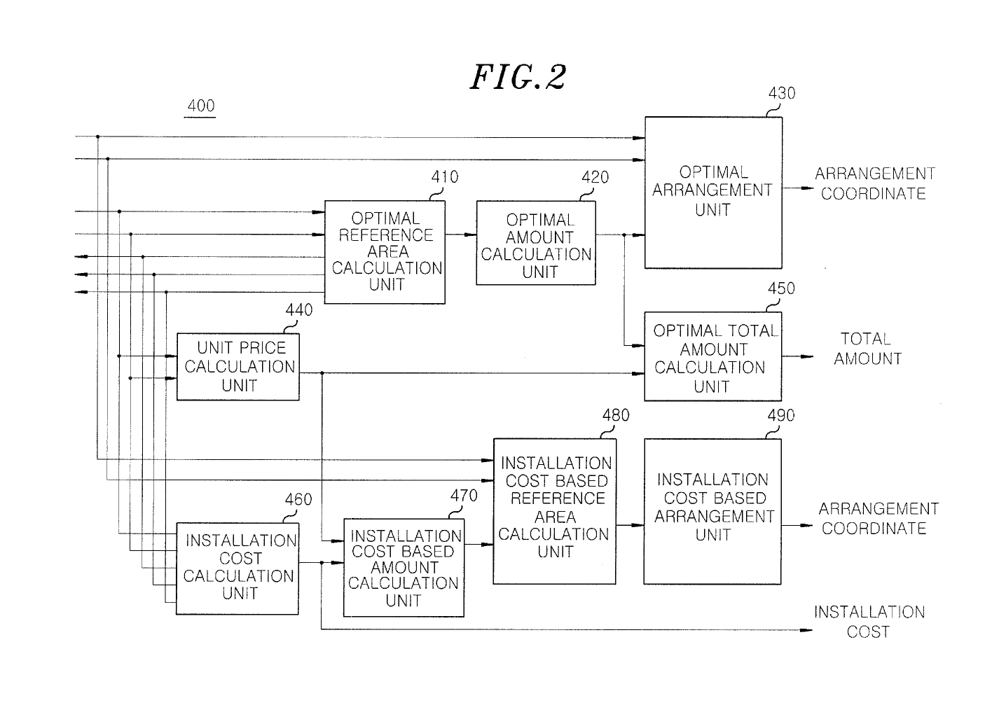

FIG. 2 is a detailed block diagram of the simulation arrangement unit for measuring instruments in accordance with an embodiment of the present invention.

Referring to FIG. 2, the simulation arrangement unit 400 includes an optimal reference area calculation unit 410 for measuring instruments, an optimal amount calculation unit 420 for measuring instrument, an optimal arrangement unit 430 for measuring instruments, a unit price calculation unit 440 for measuring instruments, an optimal total amount calculation unit 450 for measuring instrument, an installation cost calculation unit 460 for measuring instruments, an installation cost based amount calculation unit 470 for measuring instruments, an installation cost based reference area calculation unit 480 for measuring instruments, and an installation cost based arrangement unit 490 for measuring instruments.

The optimal reference area calculation unit 410 calculates an optimal reference area of the measuring instrument based on the measuring instrument installation cost information, simulation method information, measuring instrument list information and building characteristic data.

The optimal amount calculation unit 420 calculates an optimal amount of the measuring instrument based on the optimal reference area of the measuring instrument.

The optimal arrangement unit 430 calculates the optimal arrangement coordinate of the measuring instrument based on the building structure data, building energy facility distribution diagram data, optimal amount data of the measuring instrument and building characteristic data.

The unit price calculation unit 440 calculates a unit price of the measuring instrument based on the measuring instrument installation cost information, simulation method information and measuring instrument list information.

The optimal total amount calculation unit 450 calculates an optimal total amount of the measuring instrument based on the optimal amount and a unit price of the measuring instrument.

The installation cost calculation unit 460 calculates an installation cost of the measuring instrument based on the measuring instrument installation coat information, simulation method information, measuring instrument list information and building characteristic data.

The installation cost based amount calculation unit 470 calculates an installation cost based amount of the measuring instrument based on the unit price and installation cost of the measuring instrument.

The installation cost based reference area calculation unit 480 calculates an installation cost based reference area of the measuring instrument based on the installation cost based amount of the measuring instrument and building characteristic data.

The installation cost based arrangement unit 490 calculates the installation cost based arrangement coordinate of the measuring instrument based on the installation cost based reference area of the measuring instrument.

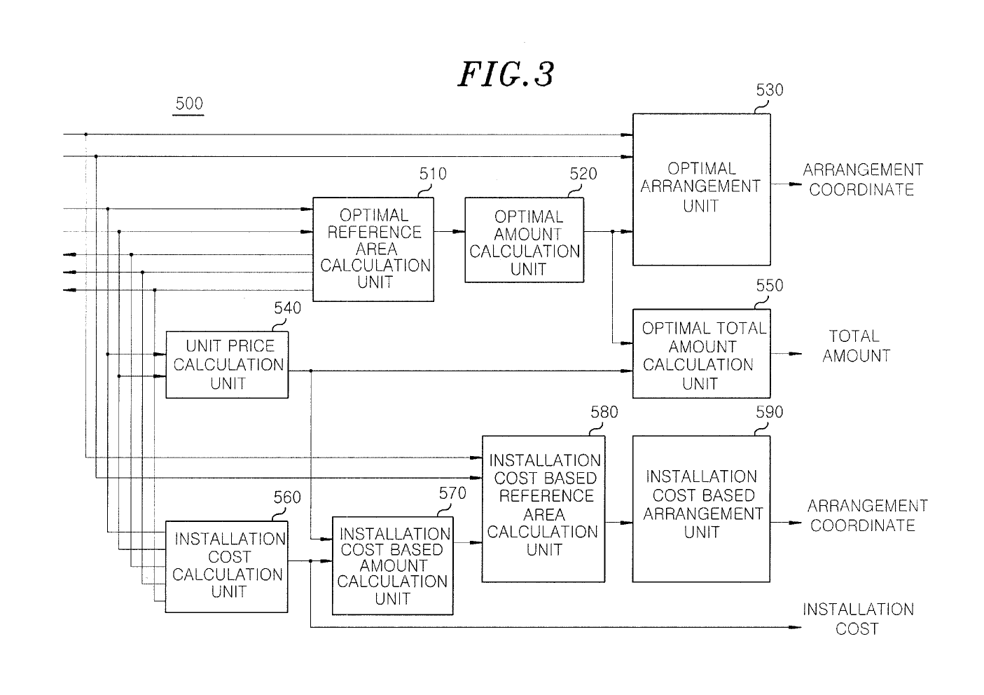

FIG. 3 is a detailed block diagram of the simulation arrangement unit for metering instruments in accordance with an embodiment of the present invention.

Referring to FIG. 3, the simulation arrangement unit 500 includes an optimal reference area calculation unit 510 for metering instruments, an optimal amount calculation unit 520 for metering instruments, an optimal arrangement unit 530 for metering instruments, a unit price calculation unit 540 for metering instruments, an optimal total amount calculation unit 550 for metering instruments, an installation cost calculation unit 560 for metering instruments, an installation cost based amount calculation unit 570 for metering instruments, an installation cost based reference area calculation unit 580 for metering instruments, and an installation cost based arrangement unit 590 for metering instruments.

The optimal reference area calculation unit 510 calculates an optimal reference area of the metering instrument based on the metering instrument installation cost information, simulation method information, metering instrument list information and building characteristic data.

The optimal amount calculation unit 520 calculates an optimal amount of the metering instrument based on the optimal reference area of the metering instrument.

The optimal arrangement unit 530 calculates an optimal arrangement coordinate of the metering instrument based on the building structure data, building energy facility distribution diagram data, optimal amount data of the metering instrument and building characteristic data.

The unit price calculation unit 540 calculates a unit price of the metering instrument based on the metering instrument installation cost information, simulation method information and metering instrument list information.

The optimal total amount calculation unit 550 calculates an optimal total amount of the metering instrument based on the optimal amount of the metering instrument and a unit price of the metering instrument.

The installation cost calculation unit 560 calculates an installation cost of the metering instrument based on the metering instrument installation cost information, simulation method information, metering instrument list information and building characteristic data.

The installation cost based amount calculation unit 570 calculates an installation cost based amount of the metering instrument based on a unit price and an installation cost of the metering instrument.

The installation cost based reference area calculation unit 580 calculates an installation cost based reference area of the metering instrument based on the installation cost based amount of the metering instrument and building characteristic data.

The installation cost based arrangement unit 590 calculates an installation cost based arrangement coordinate of the metering instrument based on the installation cost based reference area of the metering instrument.

Hereinafter, an apparatus for arrangement simulation of building energy management facilities in accordance with an embodiment of the present invention will be described in more detail with reference to FIGS. 1 to 3.

The user interface unit 100 performs functions and operations as follows.

The user interface unit receives user input information and simulation method information with respect to various measuring instrument installation cost information in each room/corridor and various metering instrument installation cost information of various facilities; and transfers the measuring instrument/metering instrument installation cost information and simulation method information to both the simulation arrangement unit 400 and the simulation arrangement unit 500.

The user interface unit receives the building information modeling information/industry foundation classes information for the facility distribution diagram DB 320, the measuring instrument DB 330 and the metering instrument DB 340.

The user interface unit transfers DB editor reading/writing to the building structure DB editor 210, and transferring the building structure information to the building structure DB editor 210 when a writing signal operates; and receives the building structure information from the building structure DB editor 210 and displaying the building structure information on a screen when a reading signal operates.

The user interface unit transfers DB editor reading/writing to the facility distribution diagram DB editor 220; transfers the building energy facility distribution diagram information to the facility distribution diagram DB editor 220 when a writing signal operates; receives the building energy facility distribution diagram information from the facility distribution diagram DB editor 220; and displays the building energy facility distribution diagram information on a screen when a reading signal operates. The user interface unit transfers DB editor reading/writing to the measuring instrument DB editor 230; transfers the measuring instrument information to the measuring instrument DB editor 230 when a writing signal operates; receives the measuring instrument information from the measuring instrument DB editor 230; and displays the measuring instrument information on a screen when a reading signal operates.

The user interface unit transfers DB editor reading/writing to the metering instrument DB editor 240; transfers the metering instrument information to the metering instrument DB editor 240 when a writing signal operates; receives the metering instrument information from the metering instrument DB editor 240; and displays the metering instrument information on a screen when a reading signal operates.

The user interface unit receives optimal or installation cost based user simulation method information; and transfers measuring instrument/metering instrument installation cost and simulation method information to the simulation arrangement unit 400 and the simulation arrangement unit 500.

The user interface unit receives a three-dimensional arrangement picture from the arrangement information visualization unit 600; and automatically arranges various measuring and metering instruments in a three-dimensional space for displaying them.

The user interface unit receives an investment earnings rate picture from the investment earnings rate information visualization unit 800; and displays investment earnings rates of each measuring instrument and each metering instrument.

The building structure DB editor 210 of the DB editing unit 200 performs functions and operations as follows.

The building structure DB editor receives building structure information from the user interface unit 100; transfers DB reading/writing to the BSDB 310; and transfers the building structure data to the BSDB 310 to store them when a writing signal operates.

The building structure DB editor transfers the DB reading/writing to the BSDB 310; receives the building structure data from the BSDB 310 when a reading signal operates to convert them into building structure information; and transfers the building structure information to the user interface unit 100.

The facility distribution diagram DB editor 220 of the DB editing unit 200 performs functions and operations as follows.

The facility distribution diagram DB editor receives the building energy facility distribution diagram information from the user interface unit 100; transfers DB reading/writing to the facility distribution diagram DB 320; and transfers the building energy facility distribution diagram data to the facility distribution diagram DB 320 to be stored when a writing signal operates.

The facility distribution diagram DB editor transfers DB reading/writing to the facility distribution diagram DB 320; receives the building energy facility distribution diagram data from the facility distribution diagram DB 320 to convert them into the building energy facility distribution diagram information when a reading signal operates; and transfers the building energy facility distribution diagram information to the user interface unit 100.

The measuring instrument DB editor 230 of the DB editing unit 200 performs functions and operations as follows.

The measuring instrument DB editor receives information on various measuring instruments such as temperature sensor, humidity sensor, temperature-humidity sensor, illuminance sensor, occupancy sensor, CO₂ sensor, fine dust sensor and pressure sensor from the user interface unit 100; transfers DB reading/writing to the measuring instrument DB 330; and transfers the measuring instrument data to the measuring instrument DB 330 to store them when a writing signal operates.

The measuring instrument DB editor transfers the DB reading/writing to the measuring instrument DB 330; receives the measuring instrument data from the measuring instrument DB 330 and converts them into measuring instrument information when a reading signal operates; and transfers the measuring instrument information to the user interface unit 100.

The metering instrument DB editor 240 of the DB editing unit 200 performs functions and operations as follows.

The metering instrument DB editor 240 receives information on various metering instruments such as electricity meter, gas meter, hot water meter, cold water meter, flow meter, and air flow meter from the user interface unit 100; transfers DB reading/writing to the metering instrument DB 340; and transfers metering instrument data to the metering instrument DB 340 to store them when a writing signal operates.

The metering instrument DB editor 240 transfers the DB reading/writing to the metering instrument DB 340; receives the metering instrument data from the metering instrument DB 340, when a reading signal operates, to convert them into metering instrument information; and transfers the metering instrument information to the user interface unit 100.

The building structure DB 310 of the building DB unit 300 performs functions and operations as follows.

The building structure DB 310 receives DB reading/writing and building structure data from the building structure DB editor 210; stores building structure data when a writing signal operates; and transfers the building structure data to the building structure DB editor 210 when a reading signal operates.

The building structure DB 310 receives building structure reading from the simulation arrangement unit 400 and the simulation arrangement unit 500; and transfers the building structure data to the simulation arrangement unit 400 and the simulation arrangement unit 500.

The facility distribution diagram DB 320 of the building DB unit 300 performs functions and operations as follows.

The facility distribution diagram DB 320 receives DB reading/writing and building energy facility distribution diagram data from the facility distribution diagram DB editor 220; stores building energy facility distribution diagram data when a writing signal operates; and transfers building energy facility distribution diagram data to the facility distribution diagram DR editor 220 when a reading signal operates.

The facility distribution diagram DB 320 receives building energy facility distribution diagram reading from the simulation arrangement unit 500; and transfers building energy facility distribution diagram data to the simulation arrangement unit 400 and the simulation arrangement unit 500.

The measuring instrument DB 330 performs functions and operations as follows.

The measuring instrument DB 330 receives DB reading/writing and sensor data from the measuring instrument DB editor 230; stores the measuring instrument data when a writing signal operates; and transfers the measuring instrument data to the measuring instrument DB editor 230 when a reading signal operates.

The measuring instrument DB 330 receives measuring instrument reading from the simulation arrangement unit 400; and transfers the measuring instrument data to the simulation arrangement unit 400.

The metering instrument DB 340 performs functions and operations as follows.

The metering instrument DB 340 receives DB reading/writing and meter data from the metering instrument DB editor 240; stores metering instrument data when a writing signal operates; and transfers the metering instrument data to the metering instrument DB editor 240 when a reading signal operates.

The metering instrument DB 340 receives a metering instrument reading from the simulation arrangement unit 500; and transfers the metering instrument data to the simulation arrangement unit 500.

The simulation arrangement unit 400 performs functions and operations as follows.

The simulation arrangement unit 400 transfers a building structure reading to the BSDB 310; receives building structure data from the BSDB 310; transfers a building energy facility distribution diagram reading to the facility distribution diagram DB 320; and receives the building energy facility distribution diagram data from the facility distribution diagram DB 320.

The simulation arrangement unit 400 transfers a sensor reading to the measuring instrument DB 330; receives sensor data from the measuring instrument DB 330; receives measuring instrument/metering instrument installation cost and simulation method information from the user interface unit 100; performs the optimal arrangement function of each measuring instrument when the optimal arrangement of each measuring instrument is selected; and transfers the optimal arrangement coordinate of each measuring instrument to the arrangement information visualization unit 600.

The simulation arrangement unit 400 transfers the optimal total amount of each measuring instrument to the investment earnings rate simulation calculation unit 700; performs an installation cost based arrangement function of each measuring instrument when an installation cost based arrangement of each measuring instrument is selected; transfers the installation cost based arrangement coordinate of each measuring instrument to the arrangement information visualization unit 600; and transfers an installation cost of each measuring instrument to the investment earnings rate simulation calculation unit 700.

The simulation arrangement unit 500 performs functions and operations as follows.

The simulation arrangement unit 500 transfers a building structure reading to the BSDB 310; receives building structure data from the BSDB 310; transfers a building energy facility distribution diagram reading to the facility distribution diagram DB 320; and receives building energy facility distribution diagram data from the facility distribution diagram DB 320.

The simulation arrangement unit 500 transfers a metering instrument reading to the metering instrument DB 340; receives metering instrument data from the metering instrument DB 340; receives measuring/metering instrument installation cost and simulation method information from the user interface unit 100; when the optimal arrangement of each metering instrument is selected, performs the optimal arrangement function of each metering instrument; and transfers the optimal arrangement coordinate of each metering instrument to the arrangement information visualization unit 600.

The simulation arrangement unit 500 transfers the optimal total amount of each metering instrument to the investment earnings rate simulation calculation unit 700; performs an installation cost based arrangement function of each metering instrument when an installation cost based arrangement of each metering instrument is selected; transfers an installation cost based arrangement coordinate of each metering instrument to the arrangement information visualization unit 600; and transfers an installation cost of each metering instrument to the investment earnings rate simulation calculation unit 700.

The arrangement information visualization unit 600 performs functions and operations as follows.

The arrangement information visualization unit 600 receives the optimal arrangement coordinate of each measuring instrument or an installation cost based arrangement coordinate of each measuring instrument from the simulation arrangement unit 400; receives the optimal arrangement coordinate of each metering instrument or the installation cost based arrangement coordinate of each metering instrument from the simulation arrangement unit 500 to convert them into a three-dimensional arrangement picture; and transfers the three-dimensional arrangement picture to the user interface unit 100.

The investment earnings rate simulation calculation unit 700 performs functions and operations as follows.

The investment earnings rate simulation calculation unit 700 receives the optimal total amount of each measuring instrument or installation cost of each measuring instrument from the simulation arrangement unit 400; receives the optimal total amount of each metering instrument or an installation cost of each metering instrument from the simulation arrangement unit 500; and calculates an investment earnings rate and transfers investment earnings rate information to the investment earnings rate information visualization unit 800.

The investment earnings rate information visualization unit 800 performs functions and operations as follows.

The investment earnings rate information visualization unit 800 receives investment earnings rate information from the investment earnings rate simulation calculation unit 700 to convert it into an investment earnings rate picture; and transfers the investment earnings rate picture to the user interface unit 100.

Hereinafter, individual components constituting the simulation arrangement unit 400 will be described in more detail.

The optimal reference area calculation unit 410 receives the measuring instrument/metering instrument installation cost and the simulation method information from the user interface unit 100 and transfers a building structure reading to the BSDB 310. The optimal reference area calculation unit 410 transfers a building energy facility distribution diagram reading to the facility distribution diagram DB 320, and a sensor reading to the measuring instrument DB 330, so as to receive sensor data from the measuring instrument DB 330. Additionally, the optimal reference area calculation unit 410 determines the optimal reference area of each measuring instrument such as temperature sensor, humidity sensor, temperature-humidity sensor, illuminance sensor, occupancy sensor, CO₂ sensor, fine dust sensor and pressure sensor in the viewpoint of performance, measurement precision and installation cost of the measuring instrument when the measuring instrument/metering instrument installation cost and simulation method information is the optimal arrangement of each measuring instrument. The optimal reference area calculation unit 410 transfers the optimal reference area of each measuring instrument to the optimal amount calculation unit 420.

The optimal amount calculation unit 420 receives the optimal reference area of each measuring instrument from the optimal reference area calculation unit 410 to calculate the optimal amount of each measuring instrument and transfers the optimal amount of each measuring instrument to the optimal arrangement unit 430 and the optimal total amount calculation unit 450. Here, an expression to calculate the optimal amount of each measuring instrument may be “optimal amount of each measuring instrument=area of room/corridor÷optimal reference area of each measuring instrument”.

The optimal arrangement unit 430 receives the building structure data from the BSDB 310 and the building energy facility distribution diagram data from the facility distribution diagram DB 320. The optimal arrangement unit 430 receives the optimal amount of each measuring instrument from the optimal amount calculation unit 420 to obtain the optimal arrangement coordinate of each measuring instrument. Further, the optimal arrangement unit 430 transfers the optimal arrangement coordinate of each measuring instrument to the arrangement information visualization unit 600.

The unit price calculation unit 440 receives the measuring instrument/metering instrument installation cost and simulation method information from the user interface unit 100. Further, the unit price calculation unit 440 receives the measuring instrument data from the measuring instrument DB 330 to determine a unit price of each measuring instrument. The unit price calculation unit 440 transfers the unit price of each measuring instrument to the optimal total amount calculation unit 450 and the installation cost based amount calculation unit 470.

The optimal total amount calculation unit 450 receives the optimal amount of each measuring instrument from the optimal amount calculation unit 420. Further, the optimal total amount calculation unit 450 receives a unit price of each measuring instrument from the unit price calculation unit 440 to calculate the optimal total amount of each measuring instrument. The optimal total amount calculation unit 450 transfers the optimal total amount of each measuring instrument to the investment earnings rate simulation calculation unit 700. Here, an expression to calculate the optimal total amount of each measuring instrument may be “optimal total amount of each measuring instrument=optimal amount of each measuring instrument×unit price of each measuring instrument”.

The installation cost calculation unit 460 receives measuring instrument/metering instrument installation cost and simulation method information from the user interface unit 100, transfers a building structure reading to the BSDB 310 and transfers a building energy facility distribution diagram reading to the facility distribution diagram DR 320. The installation cost calculation unit 460 transfers a sensor reading to the measuring instrument DB 330 to receive sensor data from the measuring instrument DB 330. Additionally, the installation cost calculation unit 460 calculates an installation cost of each measuring instrument such as temperature sensor, humidity sensor, temperature-humidity sensor, illuminance sensor, occupancy sensor, CO₂ sensor, fine dust sensor and pressure sensor in a case where the measuring instrument/metering instrument installation cost and simulation method information corresponds to an installation cost based arrangement of each measuring instrument. The installation cost calculation unit 460 transfers the installation cost of each measuring instrument to the installation cost based amount calculation unit 470 and the investment earnings rate simulation calculation unit 700.

The installation cost based amount calculation unit 470 receives the unit price of each measuring instrument from the unit price calculation unit 440 and then installation cost of each measuring instrument from the installation cost calculation unit 460 to calculate an installation cost based amount of each measuring instrument. Further, the installation cost based amount calculation unit 470 transfers an installation cost based amount of each measuring instrument to the installation cost based reference area calculation unit 480. Here, an expression to calculate an installation cost based amount of each measuring instrument may be “installation cost based amount of each measuring instrument=installation cost of room/corridor of each measuring instrument÷unit price of each measuring instrument”.

The installation cost based reference area calculation unit 480 receives building structure data from the BSDB 310, and building energy facility distribution diagram data from the facility distribution diagram DB 320. The installation cost based reference area calculation unit 480 receives installation cost based amount of each measuring instrument from the installation cost based amount calculation unit 470 to calculate an installation cost based reference area of each measuring instrument and transfers the installation cost based reference area of each measuring instrument to the installation cost based arrangement unit 490. Here, an expression to calculate an installation cost based reference area of each measuring instrument may be “installation cost based reference area of each measuring instrument=area of room/corridor÷installation cost based amount of each measuring instrument”.

The installation cost based arrangement unit 490 receives an installation cost based reference area of each measuring instrument from the installation cost based reference area calculation unit 480 to obtain an installation cost based arrangement coordinate of each measuring instrument and transfers an installation cost based arrangement coordinate of each measuring instrument to the arrangement information visualization unit 600.

Hereinafter, individual components constituting the simulation arrangement unit 500 will be described in more detail.

The optimal reference area calculation unit 510 receives the measuring instrument/metering instrument installation cost and simulation method information from the user interface unit 100 and transfers a building structure reading to the building structure DB 310. The optimal reference area calculation unit 510 transfers a building energy facility distribution diagram reading to the facility distribution diagram DB 320 to receive building energy facility distribution diagram data from the facility distribution diagram DB 320, and transfers a metering instrument reading to the metering instrument DB 340 to receive metering instrument data from the metering instrument DB 340. In a case where the measuring instrument/metering instrument installation cost and simulation method information corresponds to the optimal arrangement of each metering instrument, the optimal reference area calculation unit 510 determines the optimal reference area of each metering instrument such as electricity meter, gas meter, hot water meter, cold water meter, flow meter, and air flow meter in the viewpoint of performance, measurement precision and installation cost of the metering instrument on the basis of the building energy facility distribution diagram, and transfers the optimal reference area of each metering instrument to the optimal amount calculation unit 520.

The optimal amount calculation unit 520 receives building energy facility distribution diagram data from the facility distribution diagram DB 320 and the optimal reference area of each metering instrument from the optimal reference area calculation unit 510. The optimal amount calculation unit 520 calculates the optimal amount of each metering instrument on the basis of the building energy facility distribution diagram and transfers the optimal amount of each metering instrument to the optimal arrangement unit 530 and the optimal total amount calculation unit 550.

The optimal arrangement unit 530 receives building structure data from the BSDB 310 and the building energy facility distribution diagram data from the facility distribution diagram DB 320. The optimal arrangement unit 530 receives the optimal amount of each metering instrument from the optimal amount calculation unit 520 to obtain the optimal arrangement coordinate of each metering instrument and transfers the optimal arrangement coordinate of each metering instrument to the arrangement information visualization unit 600.

The unit price calculation unit 540 receives the measuring instrument/metering instrument installation cost and simulation method information from the user interface unit 100 and the metering instrument data from the metering instrument DB 340 to determine a unit price of each metering instrument. The unit price calculation unit 540 transfers the unit price of each metering instrument to the optimal total amount calculation unit 550 and the installation cost based amount calculation unit 570.

The optimal total amount calculation unit 550 receives the optimal amount of each metering instruments from the optimal amount calculation unit 520 and the unit price of each metering instrument from the unit price calculation unit 540 to calculate the optimal total amount of each metering instrument. Further, the optimal total amount calculation unit 550 transfers the optimal total amount of each metering instrument to the investment earnings rate simulation calculation unit 700. Here, an expression to calculate the optimal total amount of each metering instrument may be “optimal total amount of each metering instrument=optimal amount of each metering instrument×unit price of each metering instrument”.

The installation cost calculation unit 560 receives the measuring instrument/metering instrument installation cost and simulation method information from the user interface unit 100 and transfers a building structure reading to the BSDB 310. The installation cost calculation unit 560 transfers a building energy facility distribution diagram reading to the facility distribution diagram DB 320 and a metering instrument reading to the metering instrument DB 340 to receive metering instrument data from the metering instrument DB 340. Further, the installation cost calculation unit 560 calculates an installation cost of each metering instrument such as electricity meter, gas meter, hot water meter, cold water meter, flow meter, and air flow meter in a case where the measuring instrument/metering instrument installation cost and simulation method information corresponds to an installation cost based arrangement of each metering instrument. The installation cost calculation unit 560 transfers the installation cost of each metering instrument to the installation cost based amount calculation unit 570 and the investment earnings rate simulation calculation unit 700.

The installation cost based amount calculation unit 570 receives the unit price of each metering instrument from the unit price calculation unit 540 and the installation cost of each metering instrument from the installation cost calculation unit 560. The installation cost based amount calculation unit 570 calculates an installation cost based amount of each metering instrument and transfers the installation cost based amount of each metering instrument to the installation cost based reference area calculation unit 580. Here, an expression to calculate an installation cost based amount of each measuring instrument may be “installation cost based amount of each measuring instrument=installation cost of each metering instrument÷unit price of each measuring instrument”.

The installation cost based reference area calculation unit 580 receives building the structure data from the BSDB 310 and the building energy facility distribution diagram data from the facility distribution diagram DB 320. The installation cost based reference area calculation unit 580 receives an installation cost based amount of each metering instrument from the installation cost based amount calculation unit 570 to calculate an installation cost based reference area of each metering instrument and transfers the installation cost based reference area of each metering instrument to the installation cost based arrangement unit 590. Here, an expression to calculate an installation cost based reference area of each measuring instrument may be “installation cost based reference area of each measuring instrument=building energy facility distribution diagram of each metering instrument÷installation cost based amount of each measuring instrument”.

The installation cost based arrangement unit 590 receives an installation cost based reference area of each metering instrument from the installation cost based reference area calculation unit 580 to obtain an installation cost based arrangement coordinate of each metering instrument, and transfers an installation cost based arrangement coordinate of each metering instrument to the arrangement information visualization unit 600.

What is claimed is:

1. An apparatus for simulation of building energy management facilities, comprising:
a building DB unit configured to store building characteristic data including building structure data, building energy facility distribution diagram data and measuring instrument list data;
a user interface unit configured to receive installation cost information of a measuring instrument and simulation method information;
a measuring instrument simulation arrangement unit configured to capture building characteristics based on the building structure data and the building energy facility distribution diagram data and simulate an arrangement of measuring instruments included in the measuring instrument list data in accordance with the measuring instrument installation cost information and the simulation method information; and
an arrangement information visualization unit configured to visualize arrangement information generated by the measuring instrument simulation arrangement unit.

2. The apparatus of claim 1, further comprising:
a DB editing unit configured to edit the building structure data, the building energy facility distribution diagram data and the measuring instrument list data stored in the building DB unit in accordance with building information modeling information and industry foundation classes information received by the user interface unit.

3. The apparatus of claim 1, wherein the measuring instrument simulation arrangement unit provides optimal arrangement coordinate information and installation cost-based arrangement coordinate information of the measuring instrument to the arrangement information visualization unit for the visualization thereof.

4. The apparatus of claim 1, wherein the measuring instrument simulation arrangement unit is configured to provide optimal total amount information and measuring instrument installation cost information,
wherein the apparatus further comprises:
an investment earnings rate simulation calculation unit configured to calculate investment earnings rate information based on the optimal total amount information and measuring instrument installation cost information; and
an investment earnings rate information visualization unit configured to visualize the investment earnings rate information calculated.

5. The apparatus of claim 1, wherein the measuring instrument simulation arrangement unit comprises:
a measuring instrument optimal reference area calculation unit configured to calculate the optimal reference area of the measuring instrument based on the measuring instrument installation cost information, the simulation method information, the measuring instrument list information and the building characteristic data;
a measuring instrument optimal amount calculation unit configured to calculate the optical amount of the measuring instrument based on the optimal reference area of the measuring instrument;
a measuring instrument optimal arrangement unit configured to calculate the optimal arrangement coordinate of the measuring instrument based on the building structure data, the building energy facility distribution diagram data, the optimal amount data of the measuring instrument and the building characteristic data;
a measuring instrument unit price calculation unit configured to calculate unit price of the measuring instrument based on the measuring instrument installation cost information, the simulation method information and the measuring instrument list information;
a measuring instrument optimal total amount calculation unit configured to calculate the optimal total amount of the measuring instrument based on the optimal amount of the measuring instrument and the unit price of the measuring instrument;
a measuring instrument installation cost calculation unit configured to calculate an installation cost of the measuring instrument based on the measuring instrument installation cost information, the simulation method information, the measuring instrument list information and the building characteristic data;
a measuring instrument installation cost based amount calculation unit configured to calculate an installation cost based amount of the measuring instrument based on a unit price of the measuring instrument and an installation cost of the measuring instrument;
a measuring instrument installation cost based reference area calculation unit configured to calculate an installation cost based reference area of the measuring instrument based on an installation coat based amount of the measuring instrument and the building characteristic data; and
a measuring instrument installation cost based arrangement unit configured to calculate an installation cost based arrangement coordinate of the measuring instrument based on an installation cost based reference area of the measuring instrument.

6. An apparatus for simulation of building energy management facilities, comprising:
a building DB unit configured to store building characteristic data including building structure data, building energy facility distribution diagram data and metering instrument list data;
a user interface unit configured to receive metering instrument installation cost information and simulation method information;
a metering instrument simulation arrangement unit configured to capture building characteristics based on the building structure data and the building energy facility distribution diagram data and simulate an arrangement of metering instruments included in the metering instrument list data in accordance with the metering instrument installation cost information and the simulation method information; and
an arrangement information visualization unit configured to visualize arrangement information generated by the metering instrument simulation arrangement unit.

7. The apparatus of claim 6, further comprising:
a DB editing unit configured to edit the building structure data, the building energy facility distribution diagram data and the measuring instrument list data stored in the building DB unit in accordance with building information modeling information and industry foundation classes information received by the user interface unit.

8. The apparatus of claim 6, wherein the metering instrument simulation arrangement unit is configured to provide optimal arrangement coordinate information and installation cost based arrangement coordinate information of the measuring instrument to the arrangement information visualization unit for the visualization thereof.

9. The apparatus of claim 6, wherein the metering instrument simulation arrangement unit is configured to provide optimal total amount information and metering instrument installation cost information,
wherein the apparatus further comprises:
an investment earnings rate simulation calculation unit configured to calculate investment earnings rate information based on optimal total amount information and metering instrument installation cost information; and
an investment earnings rate information visualization unit configured to visualize the investment earnings rate information calculated.

10. The apparatus of claim 6, wherein the metering instrument simulation arrangement unit comprises:
a metering instrument optimal reference area calculation unit configured to calculate the optimal reference area of the metering instrument based on the metering instrument installation cost information, the simulation method information, the metering instrument list information and the building characteristic data;
a metering instrument optimal amount calculation unit configured to calculate the optical amount of the metering instrument based on the optimal reference area of the metering instrument;
a metering instrument optimal arrangement unit configured to calculate the optimal arrangement coordinate of the metering instrument based on the building structure data, the building energy facility distribution diagram data, the optimal amount data of the metering instrument and the building characteristic data;
a metering instrument unit price calculation unit configured to calculate a unit price of the metering instrument based on the metering instrument installation cost information, the simulation method information and the metering instrument list information;
a metering instrument optimal total amount calculation unit configured to calculate the optimal total amount of the metering instrument based on the optimal amount of the metering instrument and the unit price of the metering instrument;
a metering instrument installation cost calculation unit configured to calculate an installation cost of the metering instrument based on the metering instrument installation cost information, the simulation method information, the metering instrument list information and the building characteristic data;
a metering instrument installation cost based amount calculation unit configured to calculate an installation cost of the metering instrument based amount of the metering instrument based on a unit price of the metering instrument and an installation cost of the metering instrument;
a metering instrument installation cost based reference area calculation unit configured to calculate an installation cost based reference area of the metering instrument based on an installation coat based amount of the metering instrument and the building characteristic data; and
a metering instrument installation cost based arrangement unit configured to calculate an installation cost based arrangement coordinate of the metering instrument based on an installation cost based reference area of the metering instrument.

11. An apparatus for simulation of building energy management facilities, comprising:
a building DB unit configured to store building characteristic data including building structure data, building energy facility distribution diagram data, measuring instrument list data and metering instrument list data;
a user interface unit configured to receive measuring instrument installation cost information, metering instrument installation cost information and simulation method information;
a measuring instrument simulation arrangement unit configured to capture building characteristics based on the building structure data and the building energy facility distribution diagram data and simulate an arrangement of measuring instruments included in the measuring instrument list data in accordance with the measuring instrument installation cost information and the simulation method information;
a metering instrument simulation arrangement unit configured to capture building characteristics based on the building structure data and the building energy facility distribution diagram data and simulate an arrangement of metering instruments included in the metering instrument list data in accordance with the metering instrument installation cost information and the simulation method information; and
an arrangement information visualization unit configured to visualize arrangement information generated by the measuring instrument simulation arrangement unit and arrangement information generated by the metering instrument simulation arrangement unit.

12. The apparatus of claim 11, further comprising a DB editing unit configured to edit the building structure data, the building energy facility distribution diagram data, the measuring instrument list data and the metering instrument list data stored in the building DB unit in accordance with building information modeling information and industry foundation classes information received by the user interface unit.

13. The apparatus of claim 11, wherein the measuring instrument simulation arrangement unit is configured to provide optimal arrangement coordinate information and installation cost based arrangement coordinate information of the measuring instrument to be visualized by the arrangement information visualization unit, and
wherein the metering instrument simulation arrangement unit is configured to provide optimal arrangement coordinate information and installation cost based arrangement coordinate information of the measuring instrument to be visualized by the arrangement information visualization unit.

14. The apparatus of claim 11, wherein the measuring instrument simulation arrangement unit is configured to provide the optimal total amount information and measuring instrument installation cost information, and the metering instrument simulation arrangement unit provides optimal total amount information and metering instrument installation cost information,
wherein the apparatus further comprises:
an investment earnings rate simulation calculation unit configured to calculate investment earnings rate information based on the optimal total amount information and measuring instrument installation cost information, and optimal total amount information and metering instrument installation cost information; and
an investment earnings rate information visualization unit configured to visualize the investment earnings rate information calculated.

15. The apparatus of claim 11, wherein the measuring instrument simulation arrangement unit comprises:
a measuring instrument optimal reference area calculation unit configured to calculate the optimal reference area of the measuring instrument based on the measuring instrument installation cost information, the simulation method information, the measuring instrument list information and the building characteristic data;
a measuring instrument optimal amount calculation unit configured to calculate the optical amount of the measuring instrument based on the optimal reference area of the measuring instrument;
a measuring instrument optimal arrangement unit configured to calculate the optimal arrangement coordinate of the measuring instrument based on the building structure data, the building energy facility distribution diagram data, optimal amount data of the measuring instrument and the building characteristic data;
a measuring instrument unit price calculation unit configured to calculate a unit price of the measuring instrument based on the measuring instrument installation cost information, the simulation method information and the measuring instrument list information;
a measuring instrument optimal total amount calculation unit configured to calculate the optimal total amount of the measuring instrument based on the optimal amount of the measuring instrument and the unit price of the measuring instrument;
a measuring instrument installation cost calculation unit configured to calculate an installation cost of the measuring instrument based on the measuring instrument installation cost information, the simulation method information, the measuring instrument list information and the building characteristic data;
a measuring instrument installation cost based amount calculation unit configured to calculate an installation cost based amount of the measuring instrument based on a unit price of the measuring instrument and an installation cost of the measuring instrument;
a measuring instrument installation cost based reference area calculation unit configured to calculate an installation cost based reference area of the measuring instrument based on the installation coat based amount of the measuring instrument and the building characteristic data; and
a measuring instrument installation cost based arrangement unit configured to calculate an installation cost based arrangement coordinate of the measuring instrument based on the installation cost based reference area of the measuring instrument.

16. The apparatus of claim 11, wherein the metering instrument simulation arrangement unit comprises:
a metering instrument optimal reference area calculation unit configured to calculate the optimal reference area of the metering instrument based on the metering instrument installation cost information, the simulation method information, the metering instrument list information and the building characteristic data;
a metering instrument optimal amount calculation unit configured to calculate the optical amount of the metering instrument based on the optimal reference area of the metering instrument;
a metering instrument optimal arrangement unit configured to calculate the optimal arrangement coordinate of the metering instrument based on the building structure data, the building energy facility distribution diagram data, the optimal amount data of the metering instrument and the building characteristic data;
a metering instrument unit price calculation unit configured to calculate a unit price of the metering instrument based on the metering instrument installation cost information, the simulation method information and the metering instrument list information;
a metering instrument optimal total amount calculation unit configured to calculate the optimal total amount of the metering instrument based on the optimal amount of the metering instrument and the unit price of the metering strument;
a metering instrument installation cost calculation unit configured to calculate an installation cost of the metering instrument based on the metering instrument installation cost information, the simulation method information, the metering instrument list information and the building characteristic data;
a metering instrument installation cost based amount calculation unit configured to calculate an installation cost based amount of the metering instrument based on a unit price of the metering instrument and an installation cost of the metering instrument;
a metering instrument installation cost based reference area calculation unit configured to calculate an installation cost based reference area of the metering instrument based on an installation coat based amount of the metering instrument and the building characteristic data; and
a metering instrument installation cost based arrangement unit configured to calculate an installation cost based arrangement coordinate of the metering instrument based on an installation cost based reference area of the metering instrument.
